(19) United States
(12) Patent Application Publication
(10) Pub. No.: US 2025/0042780 A1
(43) Pub. Date: Feb. 6, 2025

(54) NEURAL NETWORK-BASED OPTIMIZATION FOR COAGULANT DOSING IN DESALINATION PLANTS

(71) Applicant: ACWA POWER Company, Riyadh (SA)

(72) Inventors: Thomas ALTMANN, Dubai (AE); Muhammad Ghifari RIDWAN, Dubai (AE); Ratul DAS, Thuwal (SA); Ahmed Yousry Ahmed MAHMOUD, Dubai (AE)

(73) Assignee: ACWA POWER Company, Riyadh (SA)

(21) Appl. No.: 18/593,816

(22) Filed: Mar. 1, 2024

Related U.S. Application Data
(60) Provisional application No. 63/487,839, filed on Mar. 1, 2023.

(51) Int. Cl. C02F 1/52; G05B 13/02

(52) U.S. Cl. CPC C02F 1/5209; G05B 13/027; C02F 2209/006; C02F 2209/06; C02F 2209/10; C02F 2209/11

(57) ABSTRACT

A system and a method for neural network-based optimization of coagulant dosing in a desalination plant receives operational data associated with the desalination plant to produce a filtered liquid stream from a first liquid stream. The operational data includes a first set of parameters associated with the first liquid stream. The system and method may determine a second set of parameters based on pre-processing of the first set of parameters. The system and method may also determine a third set of parameters based on the first set of parameters and the second set of parameters. The system and method may also provide the third set of parameters as input to a Neural Network (NN) model and estimate a Silt Density Index (SDI) of the first liquid stream. The system and method may modify a coagulant dosing rate in the first liquid stream based on the estimated SDI data.

### TECHNICAL FIELD

The present disclosure relates to the seawater reverse osmosis process. More specifically, the present disclosure relates to a neural network-based optimization system for coagulant dosing in industrial-scale seawater reverse osmosis desalination plants.

### BACKGROUND

In recent years, the global issue of shortage of freshwater has been increasing rapidly. The shortage of freshwater is a major problem owing to extreme weather conditions, desertification, and water pollution. As freshwater nourishes and sustains life, incessant population growth demands a greater supply of freshwater. To meet the increasing demand for freshwater, seawater reverse osmosis (SWRO) is being widely used technology to produce freshwater from seawater which is present abundantly on the earth. The SWRO process has undergone several enhancements over the last few years, but it remains an energy and chemical-intensive process.

One of the major sources of operation cost for the “SWRO” is membrane replacement cost. While membrane replacement is certainly unavoidable due to, for instance, fouling and mineral scaling. Therefore, to optimize the SWRO process, it is important to minimize organic and inorganic fouling of the membrane, thereby reducing operational costs. The fouling of the membrane (such as the semi-permeable membrane or reverse osmosis membranes) in the SWRO process occurs when impurities accumulate on the membrane surface, thereby reducing water flow and efficiency. Such accumulation of impurities may include a build-up of, for example, but not limited to, salts, organic matter, microorganisms, and the like. Such a build-up of impurities may lead to a decrease in the performance of the SWRO process.

Further, to remove organic foulants and particulates the seawater is filtered, and various chemicals are added during the pretreatment process. For example, Sodium Hypochlorite (NaOCl) may be added for disinfection, and coagulants (such as Ferric chloride FeCl₃) and flocculants may be added for agglomeration of particulates. Such agglomeration of particulates (or colloidal particles) using chemical coagulants, often coupled with media filtration, reduces colloidal fouling on reverse osmosis membranes, which is commonly used in seawater pretreatment. However, due to its inherent complexity and the absence of physical models to quantify the efficiency of coagulation, overdosing of coagulants is ubiquitously observed during this step to maintain filtered water quality. The efficiency and cost-effectiveness of the SWRO process can be optimized by optimizing the coagulant dosing.

Therefore, there is a need for a system that optimizes coagulant dosing in the SWRO process.

### SUMMARY

A system and method are provided herein that focuses on the optimization of coagulant dosing in seawater reverse osmosis desalination plants using a neural network.

In one aspect, a system for neural network-based optimization of coagulant dosing in desalination plants is provided. The system may include a memory that may be configured to store a computer executable instruction and one or more processors coupled to the memory. The one or more processors may be configured to receive operational data associated with a desalination plant to produce a filtered liquid stream from a first liquid stream. The operational data may include a first set of parameters associated with the first liquid stream. Further, the one or more processors may be configured to determine a second set of parameters based on pre-processing of the first set of parameters. The one or more processors may be further configured to determine a third set of parameters based on the first set of parameters and the second set of parameters. The third set of parameters may be a subset of the first set of parameters and the second set of parameters. The one or more processors may be further configured to provide, as an input, the third set of parameters to a Neural Network (NN) model. The NN model may be trained on a training dataset. Further, the one or more processors may be configured to estimate a Silt Density Index (SDI) data of the first liquid stream based on an output of the NN model. The one or more processors may be further configured to modify a coagulant dosing rate in the first liquid stream based on the estimated SDI data.

In one embodiment, the training dataset may include a set of historical parameters associated with one or more liquid streams and a corresponding historical SDI data associated with each of the one or more liquid streams. The one or more processors may be configured to train the NN model based on the set of historical parameters and the corresponding historical SDI data associated with each of the one or more liquid streams.

In one embodiment, the one or more processors may be further configured to re-train the NN model based on the third set of parameters, and the estimated SDI data of the first liquid stream. The one or more processors may be further configured to store the re-trained NN model in the memory.

In one embodiment, the first set of parameters associated with the first liquid stream may include at least a first turbidity value of the first liquid stream, a first Potential of Hydrogen (pH) value of the first liquid stream, a first SDI value of the first liquid stream, a first coagulant dosing rate of the first liquid stream, and a first flocculants dosing rate of the first liquid stream.

In one embodiment, the first set of parameters associated with one or more liquid streams further includes a set of historical values associated with one or more liquid streams. The set of historical values may include at least a historical turbidity value of the one or more liquid streams, a historical Potential of Hydrogen (pH) value of the one or more liquid streams, a historical SDI value of the one or more liquid streams, a historical coagulant dosing rate of the one or more liquid streams, and a historical flocculants dosing rate of the one or more liquid streams.

In one embodiment, the second set of parameters includes at least a first turbidity value of the first liquid stream, a first pH value of the first liquid stream, a first SDI value of the first liquid stream, a first coagulation dosing rate of the first liquid stream, a first flocculants dosing rate of the first liquid stream, a historical turbidity value of the one or more liquid streams, a historical pH value of the one or more liquid streams, a historical SDI value of the one or more liquid streams, a historical coagulation dosing rate of the one or more liquid streams, a historical flocculants dosing rate of the one or more liquid streams, an optimal turbidity value of the first liquid stream, an optimal pH value of the first liquid stream, an optimal SDI value of the first liquid stream, an optimal coagulation dosing rate of the first liquid stream, and an optimal flocculants dosing rate of the first liquid stream.

In one embodiment, the third set of parameters includes at least a historical turbidity value of one or more liquid streams, a first turbidity value of the first liquid stream, a first pH value of the first liquid stream, a historical pH value of the one or more liquid streams, a historical SDI value of the one or more liquid streams, a historical coagulant dosing rate of the one or more liquid streams, and an optimal coagulant dosing rate of the first liquid stream.

In one embodiment, the pre-processing of the first set of parameters includes a sequential execution of a data cleaning operation, a data transformation operation, and a data validation operation on the first set of parameters.

In one embodiment, the one or more processors may be further configured to determine the third set of parameters based on an application of a correlation-based operation on the first set of parameters and the second set of parameters.

In one embodiment, the one or more processors may be further configured to determine a relationship between each parameter of the first set of parameters and a corresponding parameter of the second set of parameters based on the application of the correlation-based operation.

In one embodiment, the one or more processors may be further configured to determine a coefficient value associated with the determined relationship between each parameter of the first set of parameters and the corresponding parameter of the second set of parameters. The determined coefficient value lies within the range of −1, and 1. The one or more processors may be further configured to determine the third set of parameters based on the determined coefficient value. Further, the one or more processors may be configured to estimate, based on the output of the NN model, the SDI data of the first liquid stream based on the determined third set of parameters.

In another aspect, the method for neural network-based optimization of coagulant dosing in desalination plants is provided. The method may include receiving operational data associated with a desalination plant to produce a filtered liquid stream from a first liquid stream. The operational data may include a first set of parameters associated with the first liquid stream. Further, the method may include determining a second set of parameters based on pre-processing of the first set of parameters. The method may further include determining a third set of parameters based on the first set of parameters and the second set of parameters. The third set of parameters may be a subset of the first set of parameters and the second set of parameters. The method may further include providing, as an input, the third set of parameters to a Neural Network (NN) model. The NN model may be trained on a training dataset. Further, the method may include estimating a Silt Density Index (SDI) data of the first liquid stream based on an output of the NN model. The method may further include modifying a coagulant dosing rate in the first liquid stream based on the estimated SDI data.

In one method embodiment, the method may further include re-training the NN model based on the third set of parameters, and the estimated SDI data of the first liquid stream. The method may further include storing the re-trained NN model.

In one method embodiment, the first set of parameters associated with the first liquid stream may include at least a first turbidity value of the first liquid stream, a first Potential of Hydrogen (pH) value of the first liquid stream, a first SDI value of the first liquid stream, a first coagulant dosing rate of the first liquid stream, and a first flocculants dosing rate of the first liquid stream.

In method embodiment, the second set of parameters includes at least a first turbidity value of the first liquid stream, a first pH value of the first liquid stream, a first SDI value of the first liquid stream, a first coagulation dosing rate of the first liquid stream, a first flocculants dosing rate of the first liquid stream, a historical turbidity value of the one or more liquid streams, a historical pH value of the one or more liquid streams, a historical SDI value of the one or more liquid streams, a historical coagulation dosing rate of the one or more liquid streams, a historical flocculants dosing rate of the one or more liquid streams, an optimal turbidity value of the first liquid stream, an optimal pH value of the first liquid stream, an optimal SDI value of the first liquid stream, an optimal coagulation dosing rate of the first liquid stream, and an optimal flocculants dosing rate of the first liquid stream.

In one method embodiment, the pre-processing of the first set of parameters includes a sequential execution of a data cleaning operation, a data transformation operation, and a data validation operation on the first set of parameters.

In one method embodiment, the method may further include determining the third set of parameters based on an application of a correlation-based operation on the first set of parameters and the second set of parameters.

In one method embodiment, the method may further include determining a relationship between each parameter of the first set of parameters and a corresponding parameter of the second set of parameters based on the application of the correlation-based operation.

In one method embodiment, the method may further include determining a coefficient value associated with the determined relationship between each parameter of the first set of parameters and the corresponding parameter of the second set of parameters. The determined coefficient value lies within the range of −1, and 1. The method may further include determining the third set of parameters based on the determined coefficient value. Further, the method may include estimating, based on the output of the NN model, the SDI data of the first liquid stream based on the determined third set of parameters.

In yet another aspect, a non-transitory computer-readable storage medium carrying one or more sequences of one or more instructions which, when executed by at least one processor, cause the system to perform operations comprising receiving operational data associated with a desalination plant to produce a filtered liquid stream from a first liquid stream. The operational data may include a first set of parameters associated with the first liquid stream. Further, the operations may include determining a second set of parameters based on pre-processing of the first set of parameters. The operations may further include determining a third set of parameters based on the first set of parameters and the second set of parameters. The third set of parameters may be a subset of the first set of parameters and the second set of parameters. The operations may further include providing, as an input, the third set of parameters to a Neural Network (NN) model. The NN model may be trained on a training dataset. Further, the operations may include estimating a Silt Density Index (SDI) data of the first liquid stream based on an output of the NN model. The operations may further include modifying a coagulant dosing rate in the first liquid stream based on the estimated SDI data.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a diagram of a network environment in which a neural network-based system for coagulant dosing optimization is implemented, in accordance with an embodiment of the disclosure;

FIG. 2 illustrates a block diagram of the system of FIG. 1, in accordance with an embodiment of the disclosure;

FIG. 3 illustrates a block diagram of exemplary operations of the neural network-based system for coagulant dosing optimization, in accordance with an embodiment of the disclosure;

FIG. 4 is a diagram that illustrates exemplary operations for the neural network-based system for coagulant dosing optimization, in accordance with an embodiment of the disclosure;

FIG. 5 illustrates a schematic diagram of a desalination plant based on the usage of the neural network-based system, in accordance with an embodiment of the disclosure; and

FIG. 6 illustrates a flowchart of an exemplary method for optimizing coagulant dosing for the desalination plant, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

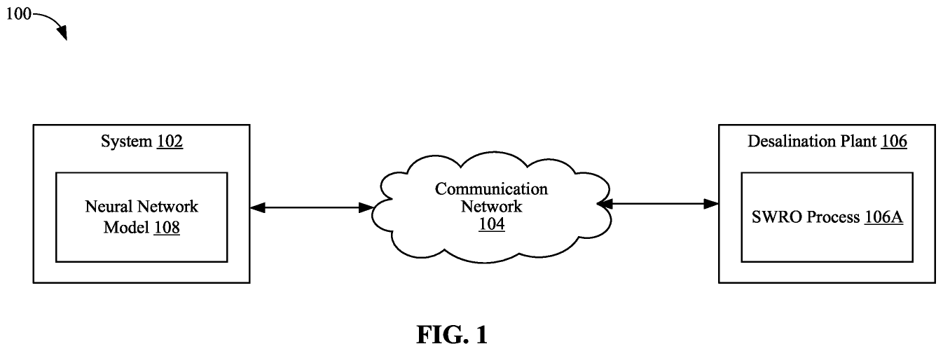

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures showing various embodiments of the neural network-based system for coagulant dozing optimization.

FIG. 1 illustrates a network environment in which a neural network-based system for coagulant dosing optimization is implemented, in accordance with an embodiment of the disclosure. With reference to FIG. 1, there is shown a network environment 100. The network environment 100 may include a system 102, a communication network 104, and a desalination plant 106. Further, the desalination plant 106 may include a seawater reverse osmosis (SWRO) process 106A.

The system 102 may correspond to a neural network-based system that may have the capability of optimizing coagulant dosing, thereby improving the efficiency and cost-effectiveness of the SWRO process 106A. The system 102 may enhance data acceptability, minimize deviations, and standardize the quality of the purified water. In an embodiment, the system 102 may correspond to a simulation system for simulating the operation of an entire SWRO plant. For example, the system 102 may correspond to a computer executable algorithm to achieve one or more functions of the neural network-based system for coagulant dosing optimization.

The system 102 may further include a neural network (NN) model 108. The NN model 108 may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on a training dataset. Each node of the neural network may correspond to a mathematical function (e.g., a sigmoid function or a rectified linear unit) with a set of parameters, tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

In the training of the neural network, one or more parameters of each node of the neural network may be updated based on whether an output of the final layer for a given input (from a training dataset) matches a correct result based on a loss function for the neural network. The above process may be repeated for the same or a different input until a minimum loss function may be achieved, and a training error may be minimized. Several methods for training are known in the art, for example, gradient descent, stochastic gradient descent, batch gradient descent, gradient boost, meta-heuristics, and the like.

The NN model 108 may include electronic data, such as, for example, a software program, code of the software program, libraries, applications, scripts, or other logic or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Although in FIG. 1, the NN model 108 is shown integrated within the system 102, the disclosure is not so limited. Accordingly, in some embodiments, the NN model 108 may be a separate entity in the system 102, without deviation from the scope of the disclosure.

In an embodiment, the system 102 may be communicatively coupled to the desalination plant 106, or any other device, via a communication network 104. The communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for example LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

All the components in the network environment 100 may be coupled directly or indirectly to the communication network 104. The components described in the network environment 100 may be further broken down into more than one component and/or combined in any suitable arrangement. Further, one or more components may be rearranged, changed, added, and/or removed.

In operation, the system 102 may be communicatively coupled to the desalination plant 106 via a communication network 104. The desalination plant 106 may correspond to a facility that may be designed to perform SWRO process 106A to produce a filtered liquid stream from a first liquid stream. The SWRO process 106A may employ the use of semi-permeable membranes that allow a solvent to pass through, while restricting solutes (such as impurities), leading to the separation of salt and freshwater. The desalination plant 106 may be configured to receive the first liquid stream. The first liquid stream may correspond to, for example, is not limited to, seawater or saltwater. For example, the first liquid stream may have a high salt content, thereby making the first liquid stream unsafe for consumption by humans.

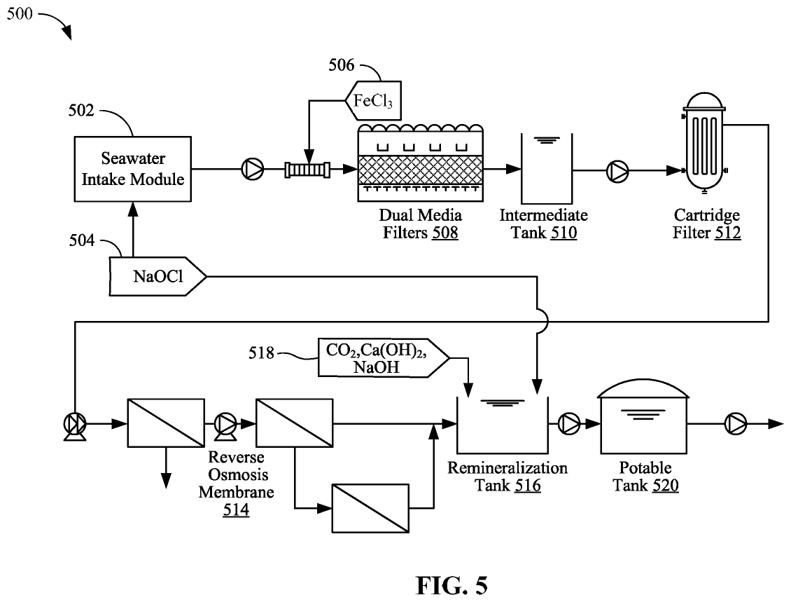

Conventionally, a seawater desalination technique may be employed to obtain the filtered liquid stream by removing excessive salt content from the first liquid stream. The filtered liquid stream may correspond to, but is not limited to, the freshwater. The potential of Hydrogen (pH) value of the filtered liquid stream may lie within the range of 5 to 7.2, making the filtered liquid stream safe for human consumption, irrigation, and other industrial purposes. Examples of various methods of treatment of the seawater desalination may include, but are not limited to, an evaporation of the first liquid stream, and a membrane separation method based on differential and selective permeation ability of the membrane. For example, the desalination plant 106 may employ the SWRO process 106A for the seawater desalination. The SWRO process 106A may refer to a technique by which the freshwater (such as the filtered liquid stream) is extracted by application of higher than the osmotic pressure of the seawater (such as the first liquid stream) with a semi-permeable membrane interposed in between. Details of the desalination plant 106 are provided, for example, in FIG. 5.

In an embodiment, the system 102 may be configured to receive operational data associated with the desalination plant 106 to produce the filtered liquid stream from the first liquid stream. Further, the operational data may include a set of parameters associated with the first liquid stream. Examples of the set of parameters may include but are not limited to a turbidity value of the first liquid stream, a Potential of Hydrogen (pH) value of the first liquid stream, a silt density index (SDI) value of the first liquid stream, a coagulant dosing rate of the first liquid stream, and a flocculants dosing rate of the first liquid stream. The turbidity value of the first liquid stream may correspond to a measure of cloudiness or haziness caused by one or more suspended particles in the seawater (the first liquid stream). The one or more suspended particles may be, for example, but not limited to, sediments, organic matter, plankton, and a plurality of microscopic organisms. Further, the pH value of the first liquid stream may correspond to a measure of the acidity and alkalinity of the seawater (the first liquid stream). The pH value of the seawater may range from, for example, but not limited to, 7.5-8.4. For example, the pH of the seawater may depend on various factors such as, but not limited to, location, depth, temperature, and biological activity.

The SDI value of the first liquid stream may correspond to a measure of the fouling potential of the first liquid stream (such as the seawater in the SWRO process. The fouling potential of the first liquid stream may refer to the potential of the seawater to coat or block the membrane (such as the semi-permeable membrane or reverse osmosis membranes) in the SWRO process 106A due to the accumulation of impurities on the membrane surface. Such impurities may include for example, but are not limited to suspended solids, organic matter, microorganisms, or scale-forming minerals. Further, the SDI value of the first liquid stream may correspond to a measure of membrane fouling based on desalination plant 106. The SDI value may indicate an extent to which suspended solids (including silts) and particulate matter (such as impurities) present in the seawater may contribute to membrane fouling, thereby reducing the efficiency of the desalination plant 106. In an example, a higher SDI value may indicate a higher fouling potential of the first liquid stream. This may lead to a need for pre-treatment of the first liquid stream to mitigate fouling and maintain the performance of the desalination plant 106.

The coagulant dosing rate of the first liquid stream may correspond to a rate at which coagulant chemicals may be added to the first liquid stream in the desalination plant 106. More specifically, the coagulant dosing rate of the first liquid stream may correspond to the volume of the coagulant chemicals to be added per unit volume of the first liquid stream. The coagulant chemicals may be added to the first liquid stream to destabilize the suspended particles in the first liquid stream, thereby allowing them to clump together and form larger aggregates that may be more easily removed through filtration. The coagulant chemicals may include for example, but not limited to Ferric chloride (FeCl₃).

Further, the flocculant dosing rate of the first liquid stream may correspond to the rate at which flocculant chemicals may be added to the first liquid stream in the desalination plant 106. More specifically, the flocculant's dosing rate of the first liquid stream may correspond to the volume of the flocculant chemicals to be added per unit volume of the first liquid stream. The flocculant chemicals may be added to the first liquid stream to promote aggregation and settling of destabilized particles and colloids into larger flocs that may be removed through filtration or sedimentation. The flocculant chemicals may include for example but are not limited to polymers. Further, the flocculant chemicals may be added to the first liquid stream after the coagulation process in which colloidal particles in the first liquid stream agglomerate using chemical coagulants (such as Ferric chloride FeCl₃).

In an embodiment, the first set of parameters associated with the one or more liquid streams may include a set of historical values associated with the one or more liquid streams. The one or more liquid streams may correspond to the seawater. The set of historical values associated with the one or more liquid streams may be associated with the operational data of the desalination plant 106 over a time-period. For example, the first set of parameters associated with the one or more liquid streams may include a set of historical values associated with the one or more liquid streams over the time-period of 3 years. In another example, the first set of parameters associated with the one or more liquid streams may include a set of historical values associated with the one or more liquid streams over the time-period of for example 1 year, 2 years, 3 years, 4 years, and the like.

The set of historical values may include at least of a historical turbidity value of the one or more liquid streams, a historical Potential of Hydrogen (pH) value of the one or more liquid streams, a historical SDI value of the one or more liquid streams, a historical coagulant dosing rate of the one or more liquid streams, and a historical flocculants dosing rate of the one or more liquid streams. In an exemplary embodiment, the first set of parameters may further include a date and a time corresponding to which the operational data associated with the desalination plant 106 may be obtained.

Further, the system 102 may be configured to determine a second set of parameters based on pre-processing of the first set of parameters. Examples of the second set of parameters 204B may include at least a first turbidity value of the first liquid stream, a first pH value of the first liquid stream, a first SDI value of the first liquid stream, a first coagulation dosing rate of the first liquid stream, a first flocculants dosing rate of the first liquid stream, a historical turbidity value of the one or more liquid streams, a historical pH value of the one or more liquid streams, a historical SDI value of the one or more liquid streams, a historical coagulation dosing rate of the one or more liquid streams, a historical flocculants dosing rate of the one or more liquid streams, an optimal turbidity value of the first liquid stream, an optimal pH value of the first liquid stream, an optimal SDI value of the first liquid stream, an optimal coagulation dosing rate of the first liquid stream, and an optimal flocculants dosing rate of the first liquid stream.

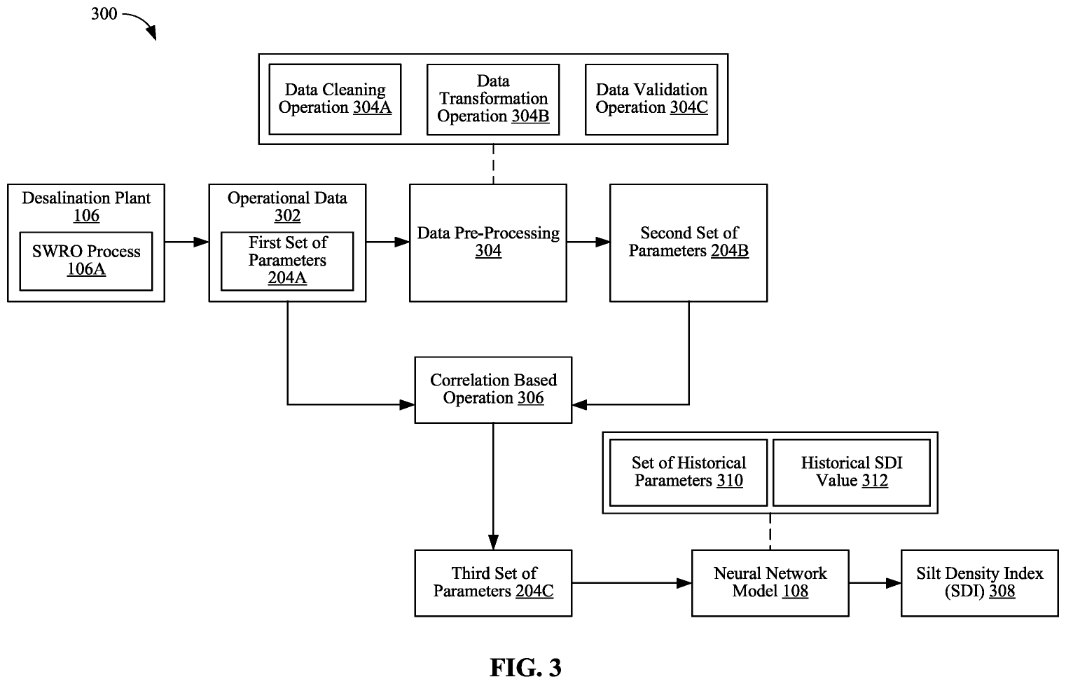

It should be noted that the first turbidity value corresponds to the current turbidity value of the first liquid stream, the historical turbidity value corresponds to preceding turbidity values of the one or more liquid streams and the optimal turbidity value corresponds to subsequent or estimated turbidity value of the first liquid streams. Similarly, the first pH value of the first liquid stream, the first SDI value of the first liquid stream, the first coagulation dosing rate of the first liquid stream, and the first flocculants dosing rate of the first liquid stream correspond to a current value associated with a corresponding parameter of the first liquid stream. Further, the historical pH value of the one or more liquid streams, the historical SDI value of the one or more liquid streams, the historical coagulation dosing rate of the one or more liquid streams, and the historical flocculants dosing rate of the one or more liquid streams corresponds to a preceding value associated with a corresponding parameter of the one or more liquid streams. The optimal pH value of the first liquid stream, the optimal SDI value of the first liquid stream, the optimal coagulation dosing rate of the first liquid stream, and the optimal flocculants dosing rate of the first liquid stream corresponds to a subsequent or estimated value associated with a corresponding parameter of the first liquid stream. Details of the determination of the second set of parameters are provided, for example, in FIG. 3.

In an embodiment, the system 102 may be further configured to determine a third set of parameters based on the first set of parameters and the second set of parameters. The third set of parameters may be a subset of the first set of parameters and the second set of parameters. Examples of the third set of parameters may include but are not limited to a historical turbidity value of the one or more liquid streams, a first turbidity value of the first liquid stream, a first pH of the first liquid stream, a historical pH value of the one or more liquid streams, a historical SDI value of the one or more liquid streams, a historical coagulant dosing rate of the one or more liquid streams, and an optimal coagulant dosing rate of the first liquid stream. Details of the determination of the third set of parameters are provided, for example, in FIG. 3.

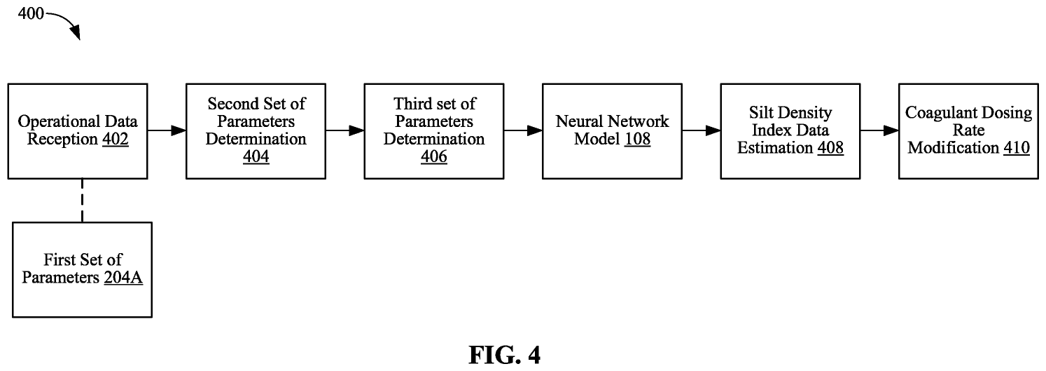

Further, the system 102 may be configured to provide, as an input, the third set of parameters to the neural network model 108. The NN model 108 may be trained on a training dataset. The system 102 may be configured to estimate the Silt Density Index (SDI) data of the first liquid stream based on an output of the neural network model 108. Further, the system 102 may be configured to modify the coagulant dosing rate in the first liquid stream based on the estimated SDI data. Details of the NN model 108 are provided, for example, in FIGS. 3 and 4.

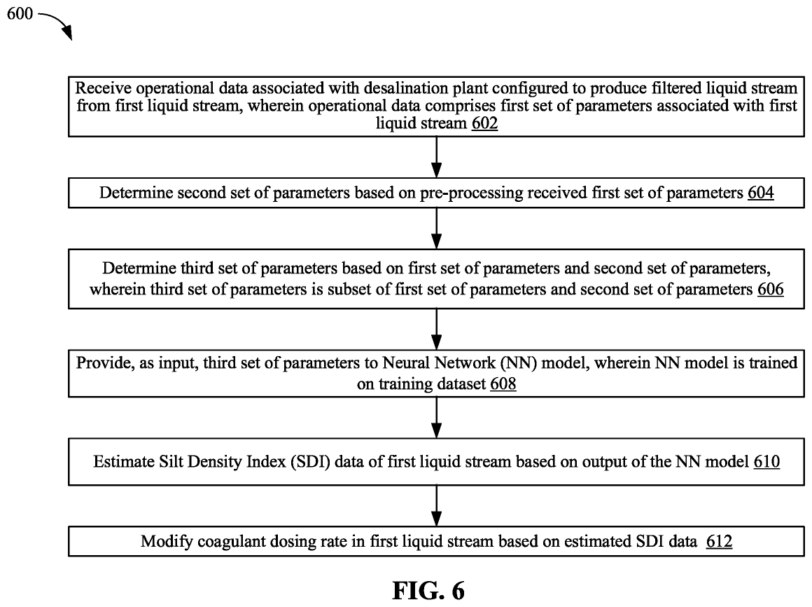

The functions or operations executed by the system 102, as described in FIG. 1, may be performed by the processor 202. Operations executed by the processor 202 are described in detail, for example, in FIG. 3, FIG. 4, FIG. 5, and FIG. 6.

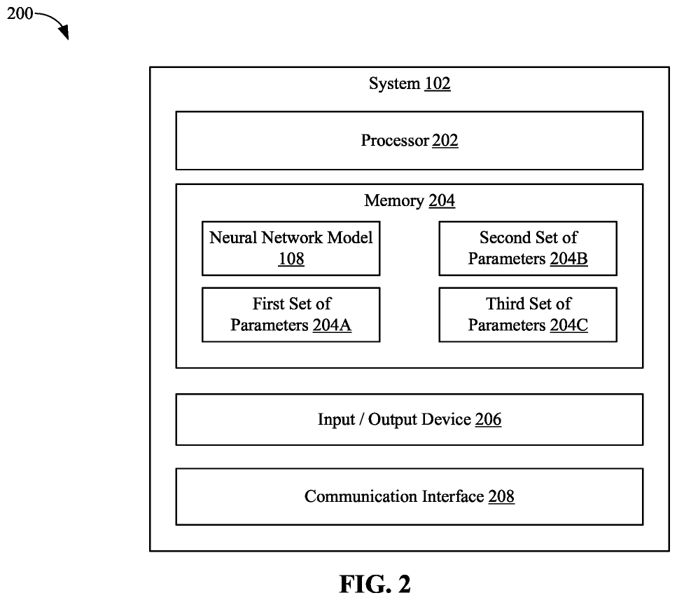

FIG. 2 illustrates a block diagram 200 of the system of FIG. 1, in accordance with an embodiment of the disclosure. FIG. 2 is explained in conjunction with FIG. 1. In FIG. 2, there is shown the block diagram 200 of the system 102. The system 102 may include at least one processor (referred to as a processor 202, hereinafter), at least one non-transitory memory (referred to as a memory 204, hereinafter), an input/output (I/O) interface 206, and a communication interface 208. The processor 202 may be connected to the memory 204, the I/O interface 206, and the communication interface 208 through one or more wired or wireless connections. The memory 204 may further include a neural network model 108, a first set of parameters 204A, a second set of parameters 204B, and a third set of parameters 204C. Although in FIG. 2, it is shown that the system 102 includes the processor 202, the memory 204, the I/O interface 206, and the communication interface 208 however, the disclosure may not be so limiting and the system 102 may include fewer or more components to perform the same or other functions of the system 102.

The processor 202 of the system 102 may be configured to perform one or more operations associated with neural network-based optimization for coagulant dosing in desalination plants. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the communication interface 208 of the system 102. The communication interface 208 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In an embodiment, the processor 202 may further receive the operational data associated with the desalination plant 106 and store the operational data in the memory 204. The operational data includes the first set of parameters 204A associated with the first liquid stream. In another embodiment, the memory 204 may be configured to store the second set of parameters 204B determined based on pre-processing of the received first set of parameters 204A. In yet another embodiment, the memory 204 may be configured to store the third set of parameters 204C determined based on the first set of parameters 204A and the second set of parameters 204B. In an example, the processor 202 may be configured to store a set of historical values of the first set of parameters associated with the one or more liquid streams in the memory 204. Further, the processor 202 may store historical data from the desalination plant 106 for at least 3 years or more.

In an embodiment, the processor 202 may be configured to train the neural network model 108 on a training dataset and store the neural network model 108 in the memory 204. The neural network model 108 may be a type of machine learning model. In an exemplary embodiment, the neural network model 108 may be used for various tasks such as, but not limited to, classification, regression, pattern recognition, and decision-making.

In some example embodiments, the I/O interface 206 may communicate with the system 102 and display the input and/or output of the system 102. As such, the I/O interface 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202.

The communication interface 208 may include the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

FIG. 3 illustrates a block diagram of exemplary operations of the neural network-based system for coagulant dosing optimization, in accordance with an embodiment of the disclosure. FIG. 3 is explained in conjunction with FIG. 1 and FIG. 2. In FIG. 3, there is shown the block diagram 300 of the exemplary operations of the neural network-based system 102. The operations may be executed by any computing system, for example, by the system 102 of FIG. 1 or the processor 202 of FIG. 2.

In an embodiment, the processor 202 may be configured to receive the operational data 302 associated with the desalination plant 106 to produce the filtered liquid stream from the first liquid stream. The desalination plant 106 may produce the filtered liquid stream from the first liquid stream using the SWRO process 106A. In an exemplary embodiment, the filtered liquid stream may be the freshwater and the first liquid stream may be the seawater.

Further, the operational data 302 may include the first set of parameters 204A associated with the first liquid stream. Examples of the first set of parameters 204A associated with the first liquid stream may include but are not limited to the first turbidity value of the first liquid stream, the first Potential of Hydrogen (pH) value of the first liquid stream, a first SDI value of the first liquid stream, the first coagulant dosing rate of the first liquid stream, and the first flocculants dosing rate of the first liquid stream.

It should be noted that the first turbidity value corresponds to the current turbidity value of the first liquid stream. Similarly, the first pH value of the first liquid stream, the first SDI value of the first liquid stream, the first coagulation dosing rate of the first liquid stream, and the first flocculants dosing rate of the first liquid stream correspond to a current value associated with a corresponding parameter of the first liquid stream. Further, the first set of parameters associated with the first liquid stream may be the parameters received on a current date and a current time corresponding to which the operational data 302 associated with the desalination plant 106 is obtained.

In an embodiment, the first set of parameters associated with the one or more liquid streams further includes a set of historical values associated with the one or more liquid streams The set of historical values comprises at least a historical turbidity value of the one or more liquid streams, a historical Potential of Hydrogen (pH) value of the one or more liquid streams, a historical SDI value of the one or more liquid streams, a historical coagulant dosing rate of the one or more liquid streams, and a historical flocculants dosing rate of the one or more liquid streams. The details about each parameter of the first set of parameters 204A are provided, for example, in FIG. 1.

In an example, the processor 202 may be configured to receive the first set of parameters 204A including the first turbidity value of the first liquid stream, the first Potential of Hydrogen (pH) value of the first liquid stream, a first SDI value of the first liquid stream before a cartridge filter, a first SI value of the first liquid stream after the cartridge filter, the first coagulant dosing rate of the first liquid stream, and the first flocculants dosing rate of the first liquid stream. Details of the cartridge filter are provided, for example, in FIG. 5.

Further, the processor 202 may be configured to perform the data pre-processing operation 304 on the first set of parameters 204A. The data pre-processing operation 304 may correspond to the pre-processing of the first set of parameters 204A. Further, the data pre-processing operation 304 may be performed to improve the quality of the received first set of parameters 204A, by removing inconsistencies or errors in values associated with each parameter of the first set of parameters 204A, thereby extracting relevant information to facilitate accurate and meaningful analysis of the first set of parameters 204A. The data pre-processing operation 304 may further reduce computation time, increase learning accuracy, avoid redundancy, and provide a better understanding of the data associated with the SWRO process 106A, by removing irrelevant parameters which may lead to poor generalization. The data pre-processing of the first set of parameters 204A may include a sequential execution of a data cleaning operation 304A, a data transformation operation 304B, and a data validation operation 304C on the first set of parameters 204A.

In an embodiment, the processor 202 may be configured to perform the data cleaning operation 304A. The data cleaning operation 304A may correspond to a process of identifying and correcting errors, inconsistencies, and inaccuracies in the values associated with each parameter of the first set of parameters 204A. The errors in the values may correspond to mistakes in the values for example, but not limited to typing errors, missing values, or incorrect values. The inconsistencies in the values may correspond to discrepancies in values for example, but not limited to contradictory values, format irregularities, or different naming conventions. The inaccuracies in the values may correspond to errors in measurement, recording, or data entry of the values. The processor 202 may be further configured to perform the data cleaning operation 304A to remove duplicate values associated with each parameter of the first set of parameters 204A. Further, the processor 202 may be configured to perform the data cleaning operation 304A to manage missing or incomplete values associated with each parameter of the first set of parameters 204A, by assigning values to the parameters or removing the parameters with missing values. Further, the data cleaning operation 304A may include standardizing data formats and values for the first set of parameters 204A. Thereafter, the data transformation operation 304B may be performed on the first set of parameters 204A.

In an embodiment, the processor 202 may be configured to perform the data transformation operation 304B. The data transformation operation 304B may correspond to a process of converting the values associated with each parameter of the first set of parameters 204A to a format that is suitable for analysis, thereby leading to the extraction of useful parameters from the first set of parameters 204A. In an exemplary embodiment, the data transformation operation 304B may include but is not limited to data transformation processes such as normalization, scaling, encoding, or feature engineering. Further, the data transformation operation 304B may include data conversions such as, but not limited to, changing data types or values of the parameters of the first set of parameters 204A. Thereafter, the data validation operation 304C may be performed on the first set of parameters 204A.

In an embodiment, the processor 202 may be configured to perform the data validation operation 304C. The data validation operation 304C may correspond to a process of verifying the accuracy, completeness, and consistency of values associated with each parameter of the first set of parameters 204A to ensure its reliability. In an exemplary embodiment, the data validation operation 304C may include checking data of the values associated with each parameter of the first set of parameters 204A based on one or more validation criteria to detect errors or anomalies. For example, the processor 202 may be configured to consider the SDI value associated with the first set of parameters 204A valid if the SDI value is above 0. Further, the processor 202 may be configured to consider the flocculants dosing rate such as, for example, polymer dosing rate valid if the polymer dosing rate is below 1 ppm.

Such a sequential execution of the data cleaning operation 304A, the data transformation operation 304B, and the data validation operation 304C on the first set of parameters 204A may be needed to further identify and remove outliers in the values associated with each parameter of the first set of parameters 204A, thereby ensuring reliability and accuracy of the values. Further, the data pre-processing operation 304 may be employed to filter and select relevant parameters of the first set of parameters 204A based on specific criteria.

Thereafter, the processor 202 may be configured to determine a second set of parameters 204B based on the pre-processing of the first set of parameters 204A. The second set of parameters 204B may include for example but is not limited to the first turbidity value of the first liquid stream, the first pH value of the first liquid stream, the first SDI value of the first liquid stream, the first coagulation dosing rate of the first liquid stream, the first flocculants dosing rate of the first liquid stream, the historical turbidity value of the one or more liquid streams, the historical pH value of the one or more liquid streams, the historical SDI value of the one or more liquid streams, the historical coagulation dosing rate of the one or more liquid streams, the historical flocculants dosing rate of the one or more liquid streams, an optimal turbidity value of the first liquid stream, an optimal pH value of the first liquid stream, an optimal SDI value of the first liquid stream, an optimal coagulation dosing rate of the first liquid stream, and an optimal flocculants dosing rate of the first liquid stream.

In an exemplary embodiment, the optimal turbidity value of the first liquid stream may be, for example, but not limited to, below 1 nephelometric turbidity unit, the optimal pH value of the first liquid stream may be, for example, but not limited to, 7.5-8.5, and the optimal SDI value of the first liquid stream may be, for example, but not limited to, below 4.

In an example, the second set of parameters 204B may further include additional parameters based on the pre-processing of the first set of parameters 204A to obtain a relationship between the first SDI value of the first liquid stream and each parameter of the first set of parameters 204A. Examples of the additional parameters may include but are not limited to shifting the optimal value of each parameter of the first set of parameters 204A to the first value of the corresponding parameter of the first set of parameters 204A, shifting the historical value of each parameter of the first set of parameters 204A to the first value of the corresponding parameter of the first set of parameters 204A, differential of the optimal value of each parameter of the first set of parameters 204A, and differential of the historical value of each parameter of the first set of parameters 204A.

In an example, the differential of the optimal value of each parameter of the first set of parameters 204A may correspond to a difference between the optimal value of each parameter of the first set of parameters 204A and the current value of each parameter of the first set of parameters 204A. For example, the differential of the optimal SDI value may correspond to a difference between the optimal SDI value and the first SDI value.

In another example, the differential of the historical value of each parameter of the first set of parameters 204A may correspond to a difference between the current value of each parameter of the first set of parameters 204A and the historical value of each parameter of the first set of parameters 204A. For example, the differential of the historical SDI value may correspond to a difference between the first SDI value and the historical SDI value.

Based on the first set of parameters 204A and the second set of parameters 204B, the processor 202 may be further configured to determine the third set of parameters 204C. The third set of parameters 204C may be the subset of the first set of parameters and the second set of parameters. The third set of parameters 204C may include but not limited to the historical turbidity value of one or more liquid streams, the first turbidity value of the first liquid stream, the first pH value of the first liquid stream, the historical pH value of the one or more liquid streams, the historical SDI value of the one or more liquid streams, a historical coagulant dosing rate of the one or more liquid streams, and an optimal coagulant dosing rate of the first liquid stream. In an example, the third set of parameters 204C may include the differential of the optimal SDI value and the differential of the historical SDI value.

In an embodiment, the processor 202 may be configured to perform the correlation-based operation 306. The processor 202 may be configured to determine the third set of parameters 204C based on an application of the correlation-based operation 306 on the first set of parameters 204B and the second set of parameters 204C. In an exemplary embodiment, the correlation-based operation 306 may correspond but not be limited to, pairwise Pearson correlation that may measure a relationship between two variables. In another exemplary embodiment, the correlation-based operation 306 may correspond to, for example, Spearman Correlation.

Further, the processor 202 may be configured to determine a relationship between each parameter of the first set of parameters 204A and a corresponding parameter of the second set of parameters 204C based on the application of the correlation-based operation 306. In an exemplary embodiment, the determined relationship between each parameter of the first set of parameters 204A and the corresponding parameter of the second set of parameters 204B may be for example but not limited to a linear relationship, or a non-linear relationship.

Further, the processor 202 may be configured to determine a coefficient value associated with the determined relationship between each parameter of the first set of parameters 204A and the corresponding parameter of the second set of parameters 204B. The determined coefficient value may lie within the range of −1, and 1. In an example, a 0-coefficient value may indicate no correlation between each parameter of the first set of parameters 204A and the corresponding parameter of the second set of parameters 204B. In another example, a −1 or +1 coefficient value may indicate a linear relationship between each parameter of the first set of parameters 204A and the corresponding parameter of the second set of parameters 204B.

Further, the processor 202 may be configured to determine the third set of parameters 204C based on the determined coefficient value. In an example, the third set of parameters 204C may include a set of parameters for which the coefficient value may indicate the linear relationship between each parameter of the first set of parameters 204A and the corresponding parameter of the second set of parameters 204B. In another example, the third set of parameters 204C may include a set of parameters for which the coefficient value may indicate the non-linear relationship between each parameter of the first set of parameters 204A and the corresponding parameter of the second set of parameters 204B.

In an example, the processor 202 may be configured to perform the correlation-based operation 306 on the first set of parameters 204A and the second set of parameters 204B to select an optimal subset of the first set of parameters 204A and the second set of parameters 204B to determine the third set of parameters 204C. Thereafter, the processor 202 may be configured to provide, as the input, the determined third set of parameters 204C to the NN model 108. Further, the processor 202 may be configured to estimate the SDI 308 data of the first liquid stream based on the output of the NN model 108.

In an embodiment, the NN model 108 may be trained on the training dataset. The training dataset may include the set of historical parameters 310 and the corresponding historical SDI data 312 associated with each of the one or more liquid streams. The set of historical parameters 310 associated with the one or more liquid streams may be associated with the operational data of the desalination plant 106 over a time-period. In an example, the set of historical parameters 310 associated with the one or more liquid streams may include but not be limited to values associated with each of the set of historical parameters over a time period of 3 years. The set of historical parameters 310 may include at least the historical turbidity value of the one or more liquid streams, the historical Potential of Hydrogen (pH) value of the one or more liquid streams, the historical SDI value of the one or more liquid streams, the historical coagulant dosing rate of the one or more liquid streams, and the historical flocculants dosing rate of the one or more liquid streams. The historical SDI data 312 associated with each of the one or more liquid streams may include but not be limited to the historical SDI value of the one or more liquid streams associated with the corresponding set of historical parameters for a given time-period.

In an embodiment, the NN model 108 may correspond to a neural network in the plurality of layers including an input layer, one or more hidden layers, and an output layer. The input layer and the one or more hidden layers may utilize a non-linear rectified linear unit (ReLU) as an activation function, where the output layer utilizes a linear activation function to optimize the neural network model. Further, the neural network model 108 may be evaluated during the training by employing mean squared error as a loss function. Further, an optimization function may be applied to the neural network that optimizes weights of the input based on a prediction of the slit density index and the loss function, called adaptive moment estimation (Adam). Adam is a first-order gradient algorithm based on adaptive estimates of lower-order moments. To evaluate the performance of the neural network model 108 after training, mean average error, and mean square error may be utilized.

In an example, the processor 202 may be configured to provide, as the input, the third set of parameters 204C to the NN model 108. The third set of parameters 204C may include for example but is not limited to the differential of the historical pH value of the one or more liquid streams, the differential of the historical turbidity value of the one or more liquid streams, the first turbidity value of the first liquid stream, the historical turbidity value of the one or more liquid streams, the first pH value of the first liquid stream, the historical pH value of the one or more liquid streams, the first SDI value of the first liquid stream before cartridge filter, the historical coagulant dosing rate of the one or more liquid streams, and the optimal coagulant dosing rate of the first liquid stream. Thereafter, the processor 202 may be configured to determine the estimated SDI 308 data of the first liquid stream based on the output of the NN model 108. In an example, the estimated SDI 308 data may include estimated SDI values of the first liquid stream. In another example, the estimated SDI 308 data may include estimated SDI values of the first liquid stream after the cartridge filter.

Further, the processor 202 may be configured to modify the coagulant dosing rate in the first liquid stream based on the estimated SDI 308 data. For example, if the estimated SDI 308 data include the estimated SDI value lower than the optimal SDI value of the first liquid stream, the processor 202 may be configured to decrease the coagulant dosing rate to achieve the optimal SDI value of the first liquid stream. A lower coagulant dosing rate may prevent overdosing of the coagulants (such as Ferric chloride FeCl₃) which may lead to excessive formation of the flocs and increased chemical consumption without significant improvement in the quality of the first liquid stream.

In another example, if the estimated SDI 308 data include the estimated SDI value higher than the optimal SDI value of the first liquid stream, the processor 202 may be configured to increase the coagulant dosing rate to achieve the optimal SDI value of the first liquid stream, thereby enhancing the coagulation dosing process. In an exemplary embodiment, the coagulant dosing may correspond to a process of improving the removal of suspended particles and colloidal matter from the first liquid stream. Further, the coagulation dosing rate may be the amount of coagulant chemical that may be added to the first liquid stream in a given time-period during the coagulation process. In an exemplary embodiment, the coagulant chemicals may be, for example, but not limited to, aluminum sulphate, poly aluminum chloride, ferric chloride, ferric sulphate, cationic polymers, and anionic polymers.

In an embodiment, the NN model 108 may be re-trained based on the third set of parameters 204C and the estimated SDI 308 data of the first liquid stream, periodically. In an exemplary embodiment, the processor 202 may be configured to re-train the NN model 108 based on the third set of parameters 204C and the estimated SDI 308 data of the first liquid stream and store the re-trained NN model 108 in the memory 204 of the system 102. In an embodiment, the NN model 108 may be re-trained, for example, but not limited to, every second day, twice a week, twice a month, twice a year, and the like. Such periodical retraining of the NN model 108 enhances the accuracy of the system 102, thereby optimizing the coagulation dossing rate in the SWRO process 106A.

FIG. 4 illustrates exemplary operations for the neural network-based system for coagulant dosing optimization, in accordance with an embodiment of the disclosure. FIG. 4 is explained in conjunction with elements of FIG. 1, FIG. 2, and FIG. 3. In FIG. 4, there is shown a block diagram 400 of operations performed by the system 102. The operations may be executed by any computing system, for example, by the system 102 of FIG. 1 or the processor 202 of FIG. 2.

At 402, the processor 202 may be configured to perform operational data reception operations. In an embodiment, the processor 202 may be configured to receive the operational data 302 associated with the desalination plant 106 to produce the filtered liquid stream from the first liquid stream. Further, the operational data 302 may include the first set of parameters 204A. The details about the first set of parameters are provided, for example, in FIG. 1.

At 404, the processor 202 may be configured to perform the second set of parameters 204B determination operation. In an embodiment, the processor 202 may be configured to determine the second set of parameters 204B based on the pre-processing of the first set of parameters 204A. The pre-processing of the first set of parameters 204A includes the sequential execution of operations including, but not limited to the data cleaning operation 304A, the data transformation operation 304B, and the data validation operation 304C on the first set of parameters 204A to determine the second set of parameters 204B. The details about the pre-processing of the first set of parameters 204A are provided, for example, in FIG. 3.

At 406, the processor 202 may be configured to perform the third set of parameters 204C determination operation. In an embodiment, the processor 202 may be configured to determine the third set of parameters 204C based on the first set of parameters 204A and the second set of parameters 204B. Further, the third set of parameters 204C may correspond to the subset of the first set of parameters 204A and the second set of parameters 204B. The processor 202 may be configured to determine the third set of parameters 204C based on the application of the correlation-based operation 306 on the first set of parameters 204A and the second set of parameters 204B. The details about the correlation-based operation 306 are provided, for example, in FIG. 3.

In an embodiment, the processor 202 may be configured to provide, as the input, the third set of parameters 204C to the NN model 108. The NN model 108 may be trained on the training dataset. In an embodiment, the training dataset may include the set of historical parameters 310 associated with the one or more liquid streams and historical SDI data 312 associated with each of the one or more liquid streams. In an embodiment, the processor 202 may be configured to train the NN model 108 based on the training dataset. For example, the processor 202 may be configured to allocate 90% of the operational data 302 associated with the desalination plant 106 for training of the NN model 108, and 10% for testing of the NN model 108. The details about the set of training of the NN model 108 are provided, for example, in FIG. 1, and FIG. 3.

At 408, the processor 202 may be configured to perform the silt density index (SDI) data estimation operation. In an embodiment, the processor 202 may be configured to estimate the SDI 308 data of the first liquid stream based on the output of the NN model 108. The details about the estimation of the SDI 308 data are provided, for example, in FIG. 3.

At 410, the processor 202 may be configured to perform the coagulant dosing rate modification operation. In an embodiment, the processor 202 may be configured to modify the coagulant dosing rate in the first liquid stream based on the estimated SDI 308 data of the first liquid stream. The coagulant dosing rate modification may be performed to optimize the efficiency and effectiveness of the coagulation process. The details about the modification of the coagulation dosing rate are provided, for example, in FIG. 3.

In an exemplary embodiment, the processor 202 may be configured to receive a user input associated with the third set of parameters 204C. Further, the processor 202 may be configured to provide, as the input, the third set of parameters 204C to the NN model 108 to estimate the SDI 308 data of the first liquid stream. Based on the estimated SDI 308 data, the user of the system 102 may further analyze the need to modify the coagulant dosing rate. Based on the analysis, the user may adjust the coagulant dosing rate in the desalination plant 106 to optimize the coagulation process. Further, the user may be, but not limited to, an individual, a person, or a group of persons using the system 102, and an owner of the system 102.

FIG. 5 illustrates a schematic diagram 500 of the desalination plant 106 based on the usage of the neural network-based system 102, in accordance with an embodiment of the disclosure. FIG. 5 is explained in conjunction with elements of FIG. 1, FIG. 2, FIG. 3, and FIG. 4. In FIG. 5, there is shown the schematic diagram 500 of the desalination plant 106. The operations of the desalination plant 106 may be executed by any computing system, for example, by the system 102 of FIG. 1 or the processor 202 of FIG. 2.

In an embodiment, the desalination plant 106 may deliver potable water (the filtered liquid stream) as a product, thereby equipped with potabilization facilities that may include a seawater intake module 502. The seawater intake module 502 may be responsible for extracting seawater (the first liquid stream) from a source. Examples of such sources may include, but are not limited to, a storage tank, an open seawater inlet pipe, and a well. The seawater intake module 502 may be an initial stage in the SWRO process 106A where the first liquid stream may be collected and directed toward the subsequent treatment process. The seawater intake module 502 may include various components that may be, for example, but not limited to, an intake pipe, a screen, and a pump.

In an embodiment, the desalination plant 106 further includes dual media filter 508. The dual media filter 508 may be a type of filtration system that may consist of two distinct layers of filtration media that may be designed to remove suspended solids, turbidity, and other impurities from the first liquid stream. In an exemplary embodiment, the two layers of the dual media filter 508 may include, for example, anthracite and sand. The anthracite may be a type of coal-based filtration media characterized by high density, hardness, and angular shape. The anthracite may serve as an upper layer of the dual media filter 508 and may be effective in removing larger particles, organic matter, and sediment from the first liquid stream. Further, the sand may form a lower layer of the dual media filter 508 and may act as a fine filtration media. It may be composed of silica sand with specific particle size distribution and uniformity. The sand may remove smaller particles, fine sediments, and remaining impurities from the first liquid stream.

In an exemplary embodiment, in the seawater intake module 502, the first liquid stream may be pumped by an intake pump and intermittently disinfected by Sodium Hypochlorite (NaOCl) 504 dosing. Subsequently, the first liquid stream is treated with coagulant (FeCl₃) 506 and flocculant for the coagulation process before entering the dual media filter 508.

In an embodiment, the desalination plant 106 may further include an intermediate tank 510. The intermediate tank 510 may be used to store and dose chemical compounds such as, but not limited to, coagulants, disinfectants, pH adjusters, and anti-scalants into the first liquid stream. The intermediate tank 510 may provide a controlled environment for mixing and dosing of the chemicals.

In an embodiment, the desalination plant 106 may further include a cartridge filter 512. The cartridge filter 512 may be a type of filtration system that may be used to remove suspended solids, particulate matter, and other impurities from the first liquid stream. The cartridge filter 512 may include a cartridge containing a porous filter media through which the first liquid stream may flow. The filter media may be the porous material contained within the cartridge housing. It may include various materials such as, but not limited to, polypropylene, polyester, cellulose, ceramic, or activated carbon. The filter media may trap suspended solids, particles, and contaminants and let the first liquid stream pass through.

Further, the coagulation dosing rate may be optimized based on the estimated SDI 308 data estimated by the neural network model 108. The first liquid stream is then filtered using the cartridge filter 512 to remove the micron-scale particle. The cartridge filter 512 may be a micron-cartridge filter. The cartridge filter 512 may be utilized for seawater polishing. In an exemplary embodiment, 12 units of cartridge filters 512 may be utilized for seawater polishing. In an example, 11 units of the cartridge filter 512 may correspond to a working unit and the remaining 1 unit of the cartridge filter 512 may correspond to a standby unit. Each cartridge filter 512 has 400 cartridge elements. Generally, the cartridge filter 512 may be a fine micro-filter of nominal size from 1 to 25 μm made of thin plastic fibers. The cartridge filter 512 may be often used as a screening device between the intake wells and the desalination plant 106. They may be considered as SWRO membrane protection rather than screening devices. The main purpose of the cartridge filter 512 may be to capture particulates in the pretreated source liquid stream that may have passed through upstream pretreatment systems. In turn, this screening prevents damage or premature fouling of the SWRO membranes. In an embodiment, the first set of parameters 204A may further include the first SDI value of the first liquid stream before the cartridge filter 512, and the first SDI value of the first liquid stream after the cartridge filter 512. Further, the first set of parameters 204A associated with the one or more liquid streams including the set of historical values associated with the one or more liquid streams includes the historical SDI value of the one or more liquid streams before the cartridge filter 512, and the historical SDI value of the one or more liquid streams after the cartridge filter 512.

In an embodiment, the desalination plant 106 may further include a reverse osmosis membrane 514. The reverse osmosis membrane 514 may be a semi-permeable membrane technology that may be used in desalination plant 106 to remove impurities, contaminants, and salts from the first liquid stream. In an exemplary embodiment, the reverse osmosis membrane 514 may remove the impurities that may be coagulated by dosing coagulant chemicals such as, but not limited to, FeCl₃ 506 in the first liquid stream. Examples of the reverse osmosis membrane 514 may be, but are not limited to, a thin film composite membrane, a cellulose triacetate membrane, a spiral wound membrane, and a hollow fiber membrane.

In an exemplary embodiment, the first liquid stream reaching a reverse osmosis membrane 514 may have an SDI value of less than 4. Before passing the first liquid stream to the reverse osmosis membrane 514, the first liquid stream may be acidified and de-chlorinated. On the contrary, if the SDI value of the filtered liquid stream is above 4, the desalination plant 106 may reduce throughput to reduce the rate of filtration to meet the requirement.

Further, a second pass of the desalination plant 106 may start with sodium hydroxide dosing to maximize boron removal. In a post-treatment process, the permeated liquid stream may be treated with limewater and CO₂ for re-mineralization and sodium hydroxide for pH correction.

In an embodiment, the desalination plant may include a remineralization tank 516. The remineralization tank 516 may be designed to reintroduce beneficial minerals back into the treated first liquid stream. Upon the filtration process of the first liquid stream to obtain the filtered liquid stream, important minerals may be stripped off from the filtered liquid stream. The remineralization tank 516 may be used to reintroduce the important minerals back into the filtered liquid stream. Examples of the remineralization tank 516 may be, but are not limited to, a passive remineralization tank, an active remineralization tank, and a chemical remineralization tank.

In an embodiment, the desalination plant 106 may further include a potable tank 520. The potable tank 520 may be a storage vessel that may be designed to store the re-mineralized filtered liquid stream. Examples of the potable tank 520 may be, but are not limited to, an above-ground potable water tank, an underground potable water tank, and an elevated potable water tank.

FIG. 6 is a flowchart that illustrates an exemplary method for optimizing coagulant dosing for the desalination plant, in accordance with an embodiment of the disclosure. FIG. 6 is explained in conjunction with elements of FIG. 1, FIG. 2, FIG. 3, FIG. 4, and FIG. 5. With reference to FIG. 6, there is shown a flowchart 600. The operations of the exemplary method may be executed by any computing system, for example, by the system 102 of FIG. 1 or the processor 202 of FIG. 2. The operations of the flowchart 600 may start at 602.

At 602, operational data associated with a desalination plant may be received. In an embodiment, the processor 202 may be configured to receive the operational data 302 associated with desalination plant 106 configured to produce a filtered liquid stream from the first liquid stream. The operational data 302 may include the first set of parameters 204A associated with the first liquid stream. Details associated with the reception of the operational data 302 are provided in FIG. 3.

At 604, a second set of parameters may be determined. In an embodiment, the processor 202 may be configured to determine the second set of parameters 204B based on pre-processing the received first set of parameters 204A. Details associated with the determination of the second set of parameters 204B are provided in FIG. 3.

At 606, a third set of parameters may be determined. In an embodiment, the processor 202 may be configured to determine the third set of parameters 204C based on the first set of parameters 204A and the second set of parameters 204B. The third set of parameters 204C may be a subset of the first set of parameters 204A and the second set of parameters 204B. Details associated with the determination of the third set of parameters 204c are provided in FIG. 3.

At 608, an input may be provided to a neural network model. In an embodiment, the processor 202 may be configured to provide, as input, the third set of parameters 204C to the neural network model 108. The neural network model 108 may be trained on the training dataset.

At 610, a silt density index (SDI) data may be estimated. In an embodiment, the processor 202 may be configured to estimate the SDI 308 data of the first liquid stream based on the output of the neural network model 108. Details associated with the estimation of the SDI value are provided in FIG. 3.

At 612, a coagulant dosing rate in the first liquid stream may be modified. In an embodiment, the processor 202 may be configured to modify the coagulant dosing rate in the first liquid stream based on the estimated SDI 308 data. Details associated with the modification of the coagulation dosing rate are provided in FIG. 3.

Alternatively, the system 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer-readable medium having stored thereon computer executable instructions, which when executed by one or more processors (such as the processor 202), cause the one or more processors to carry out operations to operate a system (e.g., the system 102) for neural network-based optimization for coagulant dosing in desalination plants. The instructions may cause the machine and/or computer to perform operations including receiving the operational data 302 associated with a desalination plant 106 to produce a filtered liquid stream from a first liquid stream. The operational data 302 may include a first set of parameters 204A associated with the first liquid stream. Further, the operations may include determining a second set of parameters 204B based on pre-processing of the first set of parameters 204A. The operations may further include determining a third set of parameters 204C based on the first set of parameters 204A and the second set of parameters 204B. The third set of parameters 204C may be a subset of the first set of parameters 204A and the second set of parameters 204B. The operations may further include providing, as an input, the third set of parameters 204C to a neural network (NN) model 108. The NN model 108 may be trained on a training dataset. Further, the operations may include estimating a Silt Density Index (SDI) data of the first liquid stream based on an output of the NN model 108. The operations may further include modifying a coagulant dosing rate in the first liquid stream based on the estimated SDI data.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

1. A system, comprising:
a memory configured to store a computer-executable instruction; and
one or more processors coupled to the memory, wherein the one or more processors are configured to:
receive operational data associated with a desalination plant to produce a filtered liquid stream from a first liquid stream, wherein the operational data comprises a first set of parameters associated with the first liquid stream;
determine a second set of parameters based on pre-processing of the first set of parameters;
determine a third set of parameters based on the first set of parameters and the second set of parameters, wherein the third set of parameters is a subset of the first set of parameters and the second set of parameters;
provide, as an input, the third set of parameters to a Neural Network (NN) model, wherein the NN model is trained on a training dataset;
estimate a Silt Density Index (SDI) data of the first liquid stream based on an output of the NN model; and
modify a coagulant dosing rate in the first liquid stream based on the estimated SDI data.

2. The system of claim 1, wherein the training dataset comprises of a set of historical parameters associated with one or more liquid streams and a corresponding historical SDI data associated with each of the one or more liquid streams, and wherein the one or more processors are further configured to:
train the NN model based on the set of historical parameters and the corresponding historical SDI data associated with each of the one or more liquid streams.

3. The system of claim 1, wherein the one or more processors are further configured to:
re-train the NN model based on the third set of parameters, and the estimated SDI data of the first liquid stream; and
store the re-trained NN model in the memory.

4. The system of claim 1, wherein the first set of parameters associated with the first liquid stream comprises at least of: a first turbidity value of the first liquid stream, a first Potential of Hydrogen (pH) value of the first liquid stream, a first SDI value of the first liquid stream, a first coagulant dosing rate of the first liquid stream, and a first flocculants dosing rate of the first liquid stream.

5. The system of claim 1, wherein the first set of parameters associated with one or more liquid streams further comprises a set of historical values associated with the one or more liquid streams, and wherein the set of historical values comprises at least of: a historical turbidity value of the one or more liquid streams, a historical Potential of Hydrogen (pH) value of the one or more liquid streams, a historical SDI value of the one or more liquid streams, a historical coagulant dosing rate of the one or more liquid streams, and a historical flocculants dosing rate of the one or more liquid streams.

6. The system of claim 1, wherein the second set of parameters comprises at least: a first turbidity value of the first liquid stream, a first pH value of the first liquid stream, a first SDI value of the first liquid stream, a first coagulation dosing rate of the first liquid stream, a first flocculants dosing rate of the first liquid stream, a historical turbidity value of the one or more liquid streams, a historical pH value of the one or more liquid streams, a historical SDI value of the one or more liquid streams, a historical coagulation dosing rate of the one or more liquid streams, a historical flocculants dosing rate of the one or more liquid streams, an optimal turbidity value of the first liquid stream, an optimal pH value of the first liquid stream, an optimal SDI value of the first liquid stream, an optimal coagulation dosing rate of the first liquid stream, and an optimal flocculants dosing rate of the first liquid stream.

7. The system of claim 1, wherein the third set of parameters comprises at least: a historical turbidity value of one or more liquid streams, a first turbidity value of the first liquid stream, a first pH of the first liquid stream, a historical pH value of the one or more liquid streams, a historical SDI value of the one or more liquid streams, a historical coagulant dosing rate of the one or more liquid streams, and an optimal coagulant dosing rate of the first liquid stream.

8. The system of claim 1, wherein the pre-processing of the first set of parameters comprises a sequential execution of a data cleaning operation, a data transformation operation, and a data validation operation on the first set of parameters.

9. The system of claim 1, wherein the one or more processors are further configured to determine the third set of parameters based on an application of a correlation-based operation on the first set of parameters and the second set of parameters.

10. The system of claim 9, wherein the one or more processors are further configured to determine a relationship between each parameter of the first set of parameters and a corresponding parameter of the second set of parameters based on the application of the correlation-based operation.

11. The system of claim 10, wherein the one or more processors are further configured to:
determine a coefficient value associated with the determined relationship between each parameter of the first set of parameters and the corresponding parameter of the second set of parameters, wherein the determined coefficient value lies within a range of −1, and 1;
determine the third set of parameters based on the determined coefficient value; and
estimate, based on the output of the NN model, the SDI data of the first liquid stream based on the determined third set of parameters.

12. A method, comprising:
receiving operational data associated with a desalination plant to produce a filtered liquid stream from a first liquid stream, wherein the operational data comprises a first set of parameters associated with the first liquid stream;
determining a second set of parameters based on pre-processing of the first set of parameters;
determining a third set of parameters based on the first set of parameters and the second set of parameters, wherein the third set of parameters is a subset of the first set of parameters and the second set of parameters;
providing, as an input, the third set of parameters to a Neural Network (NN) model, wherein the NN model is trained on a training dataset;
estimating a Silt Density Index (SDI) data of the first liquid stream based on an output of the NN model; and
modifying a coagulant dosing rate in the first liquid stream based on the estimated SDI data.

13. The method of claim 12, further comprising:
re-training the NN model based on the third set of parameters, and the estimated SDI data of the first liquid stream; and
storing the re-trained NN model.

14. The method of claim 12, wherein the first set of parameters associated with the first liquid stream comprises at least of: a first turbidity value of the first liquid stream, a first Potential of Hydrogen (pH) value of the first liquid stream, a first SDI value of the first liquid stream, a first coagulant dosing rate of the first liquid stream, and a first flocculants dosing rate of the first liquid stream.

15. The method of claim 12, wherein the second set of parameters comprises at least: a first turbidity value of the first liquid stream, a first pH value of the first liquid stream, a first SDI value of the first liquid stream, a first coagulation dosing rate of the first liquid stream, a first flocculants dosing rate of the first liquid stream, a historical turbidity value of the one or more liquid streams, a historical pH value of the one or more liquid streams, a historical SDI value of the one or more liquid streams, a historical coagulation dosing rate of the one or more liquid streams, a historical flocculants dosing rate of the one or more liquid streams, an optimal turbidity value of the first liquid stream, an optimal pH value of the first liquid stream, an optimal SDI value of the first liquid stream, an optimal coagulation dosing rate of the first liquid stream, and an optimal flocculants dosing rate of the first liquid stream.

16. The method of claim 12, wherein the pre-processing of the first set of parameters comprises a sequential execution of a data cleaning operation, a data transformation operation, and a data validation operation on the first set of parameters.

17. The method of claim 12, further comprising determining the third set of parameters based on an application of a correlation-based operation on the first set of parameters and the second set of parameters.

18. The method of claim 17, further comprising determining a relationship between each parameter of the first set of parameters and a corresponding parameter of the second set of parameters based on the application of the correlation-based operation.

19. The method of claim 18, further comprising:
determining a coefficient value associated with the determined relationship between each parameter of the first set of parameters and the corresponding parameter of the second set of parameters, wherein the determined coefficient value lies within a range of −1, and 1;
determining the third set of parameters based on the determined coefficient value; and
estimating, based on the output of the NN model, the SDI data of the first liquid stream based on the determined third set of parameters.

20. A non-transitory computer-readable medium having stored thereon, computer-executable instructions that when executed by a processor of a system, causes the processor to execute operations, the operations comprising:
receiving operational data associated with a desalination plant to produce a filtered liquid stream from a first liquid stream, wherein the operational data comprises a first set of parameters associated with the first liquid stream;
determining a second set of parameters based on pre-processing of the first set of parameters;
determining a third set of parameters based on the first set of parameters and the second set of parameters, wherein the third set of parameters is a subset of the first set of parameters and the second set of parameters;
providing, as an input, the third set of parameters to a Neural Network (NN) model, wherein the NN model is trained on a training dataset;
estimating a Silt Density Index (SDI) data of the first liquid stream based on an output of the NN model; and
modifying a coagulant dosing rate in the first liquid stream based on the estimated SDI data.
